(19) United States
(12) Patent Application Publication
(10) Pub. No.: US 2009/0015624 A1
(43) Pub. Date: Jan. 15, 2009

(54) INK-JET IMAGE FORMING APPARATUS

(75) Inventors: Hee Yuel Roh, Suwon-si (KR); Karp Sik Youn, Hwasung-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/115,660

(22) Filed: May 6, 2008

(30) Foreign Application Priority Data
Jul. 11, 2007 (KR) 2007-69688

(51) Int. Cl. B41J 2/165

(52) U.S. Cl. 347/28

(57) ABSTRACT

An image forming apparatus includes an ink-jet head having a plurality of head chips arranged in a width direction of a printing medium while forming a row, a conveyer unit to extend to correspond to the ink-jet head below the ink-jet head, and a cleaning device which is movably installed on the conveyer unit to sequentially clean the head chips while moving along the conveyer unit. The cleaning device can clean a ling printing-type image forming apparatus while moving along the conveyer unit.

### CROSS-REFERENCE TO RELATED APPLICATIONS

This application claims priority under 35 U.S.C. §119(a) from Korean Patent Application No. 10-2007-0069688, filed on Jul. 11, 2007, in the Korean Intellectual Property Office, the disclosure of which is incorporated herein in its entirety by reference.

### BACKGROUND OF THE INVENTION

1. Field of the Invention

The present general inventive concept relates to an ink-jet image forming apparatus. More particularly, the present general inventive concept relates to an ink-jet image forming apparatus employing a line-printing scheme.

2. Description of the Related Art

Generally, ink-jet image forming apparatuses spray ink on printing media (e.g., paper) to form images. Such ink-jet image forming apparatuses are divided into a shuttle-type ink-jet image forming apparatus and a line printing-type ink-jet image forming apparatus according to printing types.

The shuttle-type ink-jet image forming apparatus forms an image by using an ink-jet head reciprocating in a direction perpendicular to a conveyer direction of a printing medium. The line printing-type ink-jet image forming apparatus has a length corresponding to the width of a printing medium and forms an image by using an ink-jet head equipped with a plurality of head chips to spray ink.

Among the above ink-jet image forming apparatuses, the ink-jet image forming apparatus disclosed in Korean Patent Registration No. 10-426087 includes a print head provided with a nozzle to spray ink and a cleaning device to clean the nozzle through ultrasonic waves. The print head can move to a printing position in order to print a printing medium or to a cleaning position in order to clean the nozzle. The cleaning device includes a cleaning solution bath, which is positioned below the print head, called a cleaning position, and has a cleaning solution contained therein, and an ultrasonic vibrator, which is installed in a cleaning vessel and generates ultrasonic waves to form a water column, to clean the nozzle of the print head by using the water column.

Accordingly, after the conventional ink-jet image forming apparatus allows an ink-jet head to perform a printing operation at the printing position and then to move onto the cleaning solution bath so that the ink-jet head is positioned at the cleaning position when the necessity for the cleaning of the nozzle of the ink-jet head occurs, the ink-jet image forming apparatus operates an ultrasonic vibrator to form a water column from a cleaning solution so that the nozzle of the ink-jet head is cleaned by the water column.

However, the conventional technology is limited to the shuttle-type ink-jet image forming apparatus in which the ink-jet head is movably installed, and not employed for the line printing-type ink-jet image forming apparatus in which the ink-jet head is fixedly installed.

### SUMMARY OF THE INVENTION

The present general inventive concept provides an ink-jet image forming apparatus equipped with a cleaning device adaptable to a line-printing scheme.

Additional aspects and/or advantages of the present general inventive concept will be set forth in part in the description, which follows and, in part, will be apparent from the description, or may be learned by practice of the general inventive concept.

The foregoing and/or other aspects of the present general inventive concept are achieved by providing an image forming apparatus including an ink-jet head which comprises a plurality of head chips arranged in a width direction of a printing medium to form a row, a conveyer unit which extends corresponding to the ink-jet head below the ink-jet head, and a cleaning device which is movably installed on the conveyer unit to sequentially clean the head chips while moving along the conveyer unit.

The cleaning device may include a cleaning solution bath which contains a cleaning solution used to clean the head chip, and an ultrasonic vibrator which is mounted on a bottom surface of the cleaning solution bath to clean the head chip while vibrating.

The cleaning device may further include an outer vessel provided at an outside of the cleaning solution bath and collecting a waste cleaning solution discharged after the head chip is cleaned.

The image forming apparatus may further include a circulation device which delivers the cleaning solution to the cleaning solution bath and collects the waste cleaning solution from the outer vessel.

The circulation device may include a cleaning solution bath, which stores the cleaning solution for the cleaning solution bath, a waste cleaning solution bath, which stores the waste cleaning solution collected through the outer vessel, and a pump, which delivers the cleaning solution of the cleaning solution bath to the cleaning solution bath and delivers the waste cleaning solution of the outer vessel to the waste cleaning solution bath.

The circulation device may include a first pipe having two ends connected to the cleaning solution bath and the pump such that the cleaning solution is sucked into the pump, a second pipe having two ends connected to the pump and the cleaning solution bath such that the cleaning solution is supplied to the cleaning solution bath, and the third pipe having two ends connected to the outer vessel and the waste cleaning solution bath such that a waste cleaning solution having been collected through the outer vessel is delivered to the waste cleaning solution bath.

The head chip may have a square plate shape, and the ultrasonic vibrator may have a square plate shape such that a water column having a square-shape cross section is formed.

A plurality of head chips may be arranged on the ink-jet head in two rows, and a pair of ultrasonic vibrators may be installed such that the head chips provided in a first row and the head chips provided in a second row are cleaned by the paired ultrasonic vibrators, respectively.

The head chips provided in the first row may be arranged alternatively with the head chips provided in the second row, and the paired ultrasonic vibrators may be spaced apart from each other in a diagonal line of a bottom surface of the cleaning solution bath.

The ultrasonic vibrator may have a length and a width identical to or greater than a length and a width of the head chip.

The foregoing and/or other aspects of the present general inventive concept are achieved by providing an image forming apparatus including an ink-jet head having a plurality of head chips arranged in a direction and each having a plurality of nozzles, and a cleaning device to move along the direction to sequentially clean the head chips.

The image forming apparatus may further include a convey unit disposed along the ink-jet head in the direction, and the cleaning device may move along the convey unit in the direction to clean the head chips.

The cleaning device may include an ultrasonic vibrator to vibrate a cleaning solution to clean the head chips.

The ultrasonic vibrator may selectively operate to vibrate the cleaning solution to correspond to the respective head chips.

The head chips may be spaced-apart from each other, and the ultrasonic vibrator may not operate in a space between the adjacent head chips.

The ultrasonic vibrator may continuously operate until cleaning the head chips.

The ultrasonic vibrator may have a width to correspond to each of the head chips.

The cleaning device may include a plurality of vibrators to simultaneously clean at least two of the head chips.

The cleaning device may include a plurality of vibrators to selectively operate to clean each of the head chips.

The cleaning device may include a plurality of vibrators spaced-apart from each other to correspond to a space between the adjacent head chips.

The cleaning device may include a plurality of vibrators each having a width to correspond to a width of each of the head chips.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating an ink-jet head and a cleaning device employed for an ink-jet image forming apparatus according to an embodiment of the present general inventive concept;

FIG. 2 is a perspective view illustrating the cleaning device of FIG. 1;

FIG. 3 is a sectional view illustrating the cleaning device of FIGS. 1 and 2;

FIG. 4 is a perspective view illustrating a cleaning device employed for an ink-jet image forming apparatus according to an embodiment of the present general inventive concept; and

FIGS. 5A and 5B illustrate a cleaning device to correspond to an ink-jet head usable with an image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below to explain the present invention by referring to the figures.

Hereinafter, an ink-jet image forming apparatus 100 according to an embodiment of the present general inventive concept will be described in detail with reference to accompanying drawings. The image forming apparatus 100 includes a feeding unit 101 to pick-up and/or feed a print medium P in a feeding or transferring direction T, an ink-jet head 1 to form an image on the print medium P, and a discharge unit 102 to discharge the print medium P.

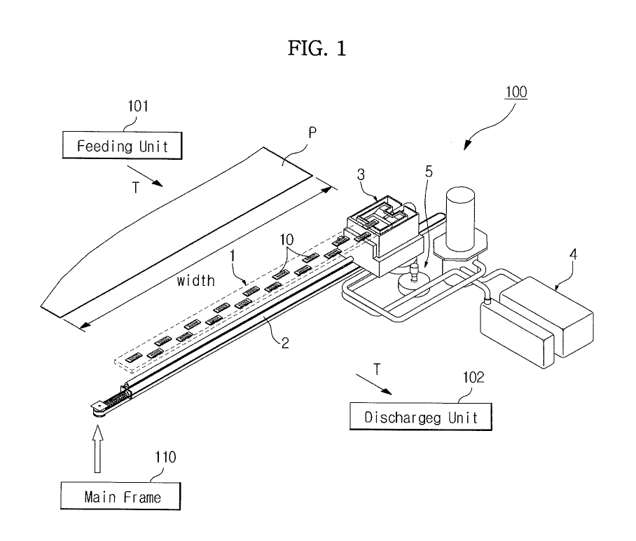

As illustrated in FIG. 1, the ink-jet image forming apparatus 100 include the ink-jet head 1, a conveyer unit 2, a cleaning device 3, a circulation device 4, and a driving device 5. The ink-jet head 1 extends widthwise along the print medium P to have a length to correspond to a width of the print medium P and to spray ink on the print medium P. The conveyer unit 2 extends corresponding to the ink-jet head 1 and is provided below the ink-jet head. The cleaning device 3 is movably mounted on the conveyer unit 2 to move along the conveyer unit 2 and clean the ink-jet head 1 positioned above the cleaning device 3. The circulation device 4 supplies a cleaning solution to be used to clean a head chip 10 of the ink-jet head, to the cleaning device 3, and retrieves (collects) a waste cleaning solution discharged in a process of cleaning of the ink-jet head 1. The driving device 5 controls the cleaning device 3 to move along the conveyer unit 2.

The ink-jet head 1 includes a plurality of nozzles to spay ink. According to the present embodiment, the ink-jet head 1 includes a plurality of head chips 10 having nozzles to spray ink, in which the head chips 10 are arranged in a lengthwise direction of the ink-jet head 1 while forming rows. According to the embodiment, the head chips 10 are arranged in two rows. The head chips 10 includes a first group of head chips disposed in a first row to be arranged alternatively with t a second group of head chips 10 disposed in a second row, in the lengthwise direction of the ink-jet head 1.

The conveyer unit 2 is mounted on a main frame 110 forming a structure of the image forming apparatus 100. The conveyer unit 2 passes through a lower portion of the cleaning device 3 such that the cleaning device 3 faces and cleans the head chips 10 provided in the ink-jet head 1 while moving along the conveyer unit 2 in a direction from a first head chip to a final head chip of the first and second groups of the head chips 10.

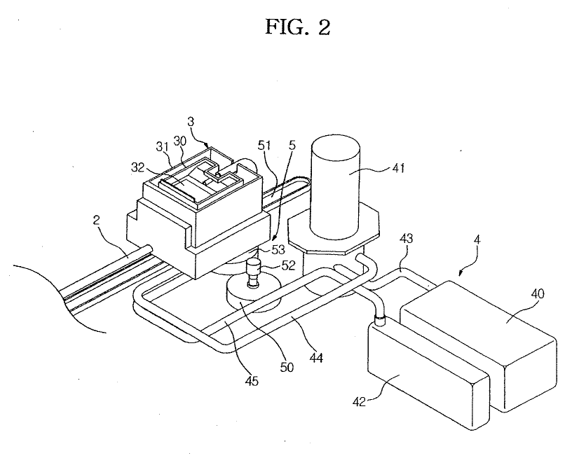

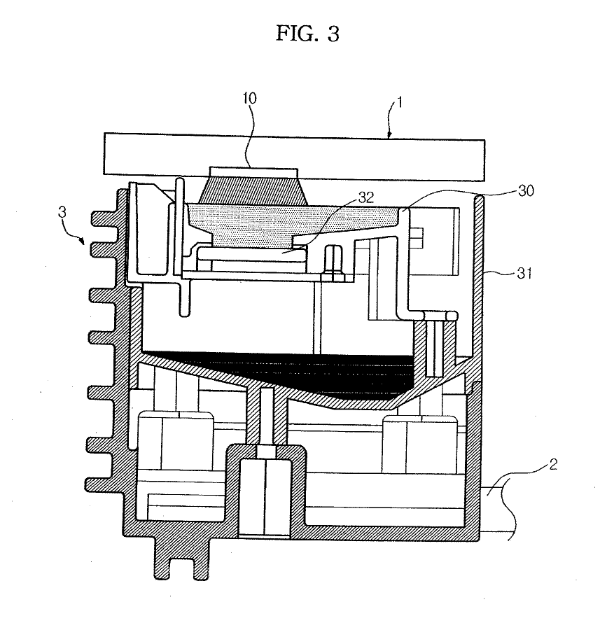

As illustrated in FIGS. 2 and 3, the cleaning device 3 includes a cleaning solution bath 30 having an opening formed on an upper portion thereof and to contain a cleaning solution in order to clean the head chips 10 of the ink-jet head 1 above the cleaning device 3, an outer vessel 31 provided at an outside of the cleaning solution bath 30 to accommodate the cleaning solution bath 30 to collect a waste cleaning solution discharged in the process of cleaning the ink-jet head 1, and a ultrasonic vibrator 32 mounted on a bottom surface of the cleaning solution bath 30 to vibrate due to power supplied from a power source which may be a power source included in the image forming apparatus 100. According to the present embodiment, the ultrasonic vibrator 32 includes a piezoceramic actuator having a square plate shape. However, the present general inventive concept is not limited thereto.

The circulation device 4 includes a cleaning solution bath 40 to contain a cleaning solution to be supplied to the cleaning solution bath 30, a pump 41 to pump up the cleaning solution from the cleaning solution bath 40 to supply the cleaning solution to the cleaning solution bath 30, and a waste cleaning solution bath 42 to store or contain the waste cleaning solution retrieved (collected) through the outer vessel 31. In this case, the cleaning solution bath 30 and the outer vessel 31 are connected to the cleaning solution bath 40, the pump 41, and the waste cleaning solution bath 42 through a plurality of pipes (e.g., first, second, and third pipes) 43, 44, and 45 such that a cleaning solution or a waste cleaning solution can be delivered. The first pipe 43 has both ends connected to the cleaning solution bath 40 and the pump 41 such that the cleaning solution is sucked into the pump 41. The second pipe 44 has both ends connected to the pump 41 and the cleaning solution bath 30 such that a cleaning solution is supplied to the cleaning solution bath 30. The third pipe 45 has both ends connected to the outer vessel 31 and the waste cleaning solution bath 42 such that a waste cleaning solution having been retrieved (collected) through the outer vessel 31 is delivered to the waste cleaning solution bath 42.

The driving device 5 includes a driving motor 50, a driving belt 51, and a pair of gears 52 and 53. The driving motor 50 generates a driving force using a power supplied from a power source which may be included in the image forming apparatus 100. The driving belt 51 delivers the driving force generated from the driving motor 50 to the cleaning device 3 such that the cleaning device 3 is moved along the conveyer unit 2. The gears 52 and 53 deliver the driving force generated from the driving motor 50 to the driving belt 51. The driving belt 51 moves in an endless loop, and the cleaning device 3 is mounted on or connected to a predetermined position of the driving belt 51 such that the driving belt 51 moves along the lengthwise direction of the ink-jet head 1 to move the cleaning device 3 together with the driving belt 51 between a first head chip to a last head chip disposed along the lengthwise direction.

Hereinafter, an operation of the image forming apparatus having the above-described structure will be described.

First, a cleaning solution is sucked to the pump 41 from the cleaning solution bath 40 through the first pipe 43 according to the operation of the pump 41 and then supplied to the cleaning solution bath 30 through the second pipe 44. If an AC voltage is applied to the ultrasonic vibrator 32 after the cleaning solution bath 30 is filled with the cleaning solution, the cleaning solution of the cleaning solution bath 30 is vibrated by the ultrasonic-vibrator 32, so that a liquid column protrudes upward to clean a portion of the ink-jet head 1 provided above the cleaning solution bath 30. When the head chip 10 is cleaned, a waste cleaning solution is retrieved or collected into the outer vessel 31 provided at the outside of the cleaning solution bath 30, and delivered and stored into the waste cleaning solution bath 42 through the third pipe 45.

In the process of cleaning the ink-jet head 1 as described above, the cleaning device 3 is moved. In other words, the driving motor 50 operates to deliver a driving force generated therefrom to the cleaning device 30 through the gears 52 and 53 and the driving belt 51. As a result, the cleaning device 3 is moved along the conveyer unit 2 in the direction from the first side of the ink-jet head 1 to the second side of the ink-jet head 1 to clean the head chips 10, which is mounted on the bottom surface of the ink-jet head 1, in the direction from the first head chip from the final head chip.

The ultrasonic vibrator 32 can have widths to generate to the liquid column to correspond to a bottom surface of each head chip such that the bottom surface of each head chip and the nozzles formed on the bottom surface of each head chip can be cleaned. Accordingly, a width of the ultrasonic vibrator 32 may correspond to a width of the head chip in a direction perpendicular to the lengthwise direction. It is possible that the width of the ultrasonic vibrator 32 may correspond to a width of two rows of the head chips in the direction perpendicular to the lengthwise direction when the ink-jet head 1 has two rows of the head chips.

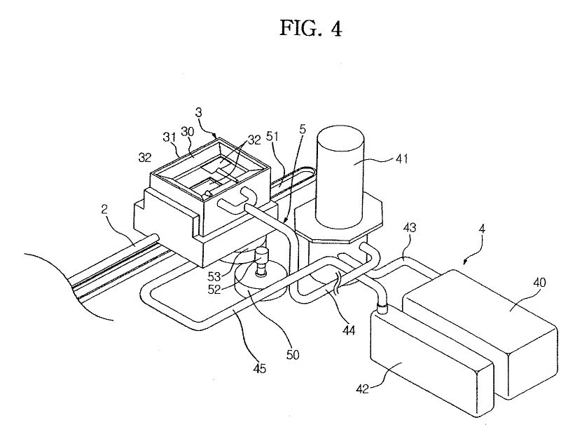

Hereinafter, an ink-jet image forming apparatus according to an embodiment of the present general inventive concept will be described with reference to FIG. 4.

Referring to FIGS. 1 and 4, the cleaning device 3 employed for the ink-jet image forming apparatus according to the present embodiment includes a pair of ultrasonic vibrators 32 on the bottom surface of the cleaning solution bath 30 such that the plural head chips 10 provided in two rows are individually cleaned in a row direction.

In this case, since the head chips 10 provided in the first row are arranged alternatively with the head chips 10 provided in the second row, the paired ultrasonic vibrators 32 are spaced apart from each other in a diagonal direction of the cleaning solution bath 30, so that one of the paired ultrasonic vibrator 32 can clean one of the head chips 10 provided in the first row, and the other can clean the other one of the head chips 10 provided in the second row.

Accordingly, the cleaning device 3 can clean at lease two head chips 10 at once. The two chips 10 are disposed in the first and second rows or in the diagonal direction.

The ultrasonic vibrator 32 according to the present embodiment has a square plate shape to form a liquid column corresponding to the head chip 10 having a square plate shape so that the head chips 10 can be effectively cleaned. If the above ultrasonic vibrator 32 having a square plate shape vibrates at a predetermined number of vibrations, a liquid column having a cross section similar to a square shape is formed from the cleaning solution contained in the cleaning solution bath 30.

In this case, a square-shape cross section of the liquid column formed by the ultrasonic vibrator 32 is gradually reduced from a lower end to an upper end thereof in a direction from the ultrasonic vibrator 32 to the head chip 10. Accordingly, when the cross section of the ultrasonic vibrator 32 is greater than the cross section of the head chip 10, a liquid column having a cross section capable of cleaning the head chip 10 can be formed. In other words, the length and the width of the ultrasonic vibrator 32 may be identical to or greater than the length and the width of the head chip 10.

It is possible that the ultrasonic vibrator 32 may have a rectangular shape to form a liquid column corresponding to the head chip 10 having a rectangular plate shape so that the head chips 10 can be effectively cleaned. The present general inventive concept is not limited thereto. It is also possible that the ultrasonic vibrator 32 may have a different shape to form a liquid column corresponding to a shape of the head chip 10 such that the head chips 10 are effectively cleaned.

Hereinafter, the operation of the cleaning device 3 employed for the ink-jet image forming apparatus having the above-described structure will be described.

The cleaning device 3 is moved by the driving device 5 along the conveyer unit 2, so that one of the paired ultrasonic vibrator 32 of the cleaning solution bath 30 is provided below one of the head chips 10 arranged in the first row, and the other is provided below one of the head chips 10 arranged in the second row.

In this state, if an AC voltage is applied to the two ultrasonic vibrators 32, a cleaning solution of the cleaning solution bath 30 is vibrated by the ultrasonic vibrators 32, so that liquid columns protrude upward to clean two head chips 10 positioned above the two ultrasonic vibrators 32. In this case, since the ultrasonic vibrators 32 have a square plate shape corresponding to the head chips 10, the liquid column has a square-shape cross section. Accordingly, the unnecessary cleaning for remain parts except for the head chips 10 is minimized.

After one head chip 10 in each row has been cleaned, the cleaning device 3 is moved by the driving device 5 and provided below head chips 10 adjacent to the head chips 10 having been cleaned, so as to clean the adjacent head chips 10.

Accordingly, the above operations are repeatedly performed, so that the plural head chips 10 provided on the ink-jet head 1 in two rows are sequentially cleaned in the direction from the first head chip to the final head chip.

The ultrasonic vibrators 32 may alternatively or selectively operate such that the head chips 10 can be alternatively or selectively cleaned. When the head chips 10 in the same row are spaced-apart, the ultrasonic vibrator 32 may intermittently operate to clean the corresponding head chips 10 such that the liquid column is not generated to correspond to the bottom surface of the ink-jet head between the adjacent head chips 10. it is also possible that the ultrasonic vibrators 32 may continue to operate to clean a first chip to a last chip.

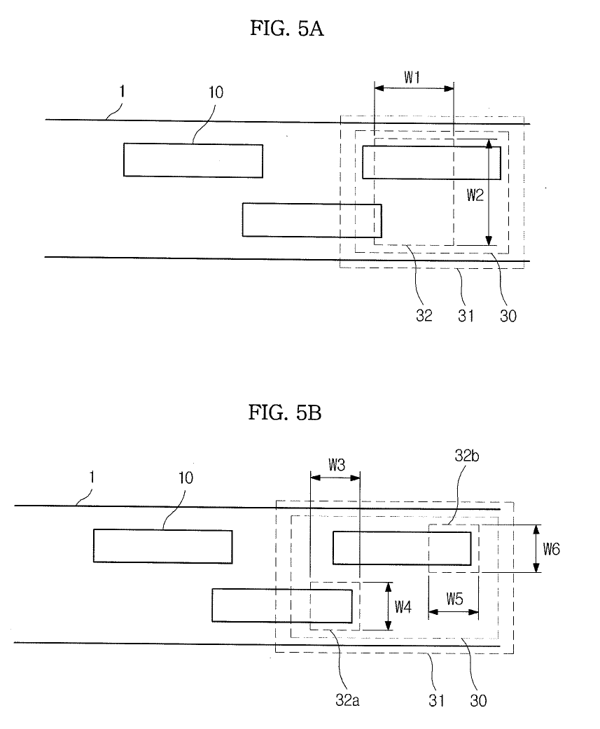

FIGS. 5A and 5B illustrate a cleaning device to correspond to an ink-jet head usable with an image forming apparatus to illustrate relationships between the head chips 10 and the ultrasonic vibrators 30. When the cleaning device 30 includes a single vibrator 32, widths W1 and W2 of the vibrator 32 may correspond to the head chips 10. Although FIG. 5A illustrates the width W2 of the vibrator 32 to correspond to the two head chips 10, it is possible that the width W2 of the vibrator 32 may correspond to only one head chip 10. When the cleaning device 30 includes two or more vibrators 32 (32a and 32b), widths W3 and W4 of the vibrator 32a and widths W5 and W6 may be determined to clean the corresponding head chips 10. Although FIG. 5B illustrates the widths W4 and W6 wider than widths of the head chips 10, the width W4 and W6 may vary according to a shape of the liquid column and a shape of the head chips.

As described above, an ink-jet image forming apparatus according to the present general inventive concept includes a conveyer unit lengthwise extending corresponding to the ink-jet head below the ink-jet head and a cleaning device movably installed on a driving device, so that the cleaning device can clean an ink-jet head of a line printing-type image forming apparatus while moving along the conveyer unit.

Although few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. An image forming apparatus comprising:
an ink-jet head having a plurality of head chips arranged in a width direction of a printing medium while forming a row;
a conveyer unit to extend to correspond to the ink-jet head below the ink-jet head; and
a cleaning device movably installed on the conveyer unit to sequentially clean the head chips while moving along the conveyer unit.

2. The image forming apparatus of claim 1, wherein the cleaning device comprises:
a cleaning solution bath to contain a cleaning solution to clean the head chip; and
an ultrasonic vibrator mounted on a bottom surface of the cleaning solution bath to clean the head chip while vibrating.

3. The image forming apparatus of claim 2, wherein the cleaning device further comprises an outer vessel provided at an outside of the cleaning solution bath and collecting a waste cleaning solution discharged after the head chip is cleaned.

4. The image forming apparatus of claim 3, further comprising:
a circulation device to deliver the cleaning solution to the cleaning solution bath and to collect the waste cleaning solution from the outer vessel.

5. The image forming apparatus of claim 4, wherein the circulation device comprises:
a cleaning solution bath to store the cleaning solution for the cleaning solution bath;
a waste cleaning solution bath to store a waste cleaning solution collected through the outer vessel; and
a pump to deliver the cleaning solution of the cleaning solution bath to the cleaning solution bath and to deliver the waste cleaning solution of the outer vessel to the waste cleaning solution bath.

6. The image forming apparatus of claim 5, wherein the circulation device comprises:
a first pipe having two ends connected to the cleaning solution bath and the pump such that the cleaning solution is sucked into the pump;
a second pipe having two ends connected to the pump and the cleaning solution bath such that the cleaning solution is supplied to the cleaning solution bath; and
a third pipe having two ends connected to the outer vessel and the waste cleaning solution bath such that a waste cleaning solution having been collected through the outer vessel is delivered to the waste cleaning solution bath.

7. The image forming apparatus of claim 2, wherein the head chips have a square plate shape, and the ultrasonic vibrator has a square plate shape such that a water column having a square-shape cross section is formed.

8. The image forming apparatus of claim 7, wherein the plurality of head chips are arranged on the ink-jet head in two rows, and the ultrasonic vibrator comprises a pair of ultrasonic vibrators installed such that the head chips provided in a first row and the head chips provided in a second row are cleaned by the paired ultrasonic vibrators, respectively.

9. The image forming apparatus of claim 8, wherein the head chips provided in the first row are arranged alternatively with the head chips provided in the second row, and the paired ultrasonic vibrators are spaced apart from each other in a diagonal line of a bottom surface of the cleaning solution bath.

10. The image forming apparatus of claim 7, wherein the ultrasonic vibrator has a length and a width identical to or greater than a length and a width of the head chip.

11. The image forming apparatus of claim 1, wherein the ultrasonic vibrator selectively operates to vibrate the cleaning solution to correspond to the respective head chips.

12. The image forming apparatus of claim 1, wherein the head chips are spaced-apart from each other, and the ultrasonic vibrator does not operate in a space between the adjacent head chips.

13. The image forming apparatus of claim 1, wherein the cleaning device comprises a plurality of vibrators to simultaneously clean at least two of the head chips.

14. The image forming apparatus of claim 1, wherein the cleaning device comprises a plurality of vibrators to selectively operate to clean each of the head chips.
